(19) United States
(12) Patent Application Publication
(10) Pub. No.: US 2024/0269860 A1
(43) Pub. Date: Aug. 15, 2024

(54) COMPACT ROBOTIC CLEANER FOR HAZARDOUS ENVIRONMENTS

(71) Applicant: ECOSERV TECHNOLOGIES, LLC, Abbeville, LA (US)

(72) Inventors: Troy Johnson, LaPorte, TX (US); Michael J. Arcediano, League City, TX (US); Timothy Patrick Kelly, II, League City, TX (US)

(73) Assignee: ECOSERV TECHNOLOGIES, LLC, Abbeville, LA (US)

(21) Appl. No.: 18/166,807

(22) Filed: Feb. 9, 2023

(51) Int. Cl. B25J 11/00; A47L 5/12; A47L 9/28; B08B 5/04; B08B 7/04; B08B 9/08; B25J 5/00; B25J 19/02

(52) U.S. Cl. CPC B25J 11/0085; A47L 5/12; A47L 9/2815; B08B 5/04; B08B 7/04; B08B 9/08; B25J 5/005; B25J 19/021; A47L 2201/04; A47L 2201/06

(57) ABSTRACT

A robotic cleaner for removing material from a vessel, such as but not limited to a sumps, and storage tank, includes a chassis, elongated track members, and a cleaning head. A first elongated track member is on a first side of the chassis and a second elongated track member is on a second side of the chassis, and the elongated track members enable movement of the robotic cleaner along a surface. The cleaning head is supported by the chassis and is nested between the first and second elongated track members such that the first elongated track member and the second elongated track member overlap the cleaning head in a lateral direction. An inlet of the cleaning head may face a forward direction of the robotic cleaner.

### FIELD OF THE INVENTION

The present disclosure relates generally to systems and methods for the removal of materials from tanks, online sumps, or other vessels, and more particularly to systems and methods for cleaning and removing solids, fluids, slurries, and sludge from tanks, vessels, or other hazardous environments.

### BACKGROUND

Many industries use tanks, sumps and other vessels to store various materials. As examples, oil and gas, chemical production and distribution, transportation (including train cars, tanker cars, and ships), manufacturing, utilities, printing, pulp and paper, agriculture, pharmaceutical, and distilleries, among other industries, use tanks and other vessels to store various types of materials such as hazardous debris, contaminants, various chemicals, etc. Such confined spaces and the content contained therein may make it unsafe for humans to enter for draining, cleaning, and/or maintenance. As such, conventional tank cleaning is often a long stringent, hazardous, and labor-intensive task. For example, conventional methods of tank, sump and vessel cleaning require operator exposure to dangerous environments. The work of an operator typically involves manually placing a remotely operated vehicle (ROV) into position in an enclosed and/or confined area, locking the ROV into place, controlling the ROV to perform a specified task, and removing the ROY from the enclosed area. ROVs have traditionally been used for a variety of reasons, including reduced costs, increased time-effectiveness, increased strength capabilities over human workers, and improved safety by reducing man hours spent in confined spaces. However, existing ROVs are still bulky and may be difficult to position and maneuver within closed containers, thereby making it difficult to focus on specific areas in need of cleaning. Existing ROVs are also susceptible to clogging due to debris within the vessel, thereby requiring a worker to enter the hazardous environment to troubleshoot.

### SUMMARY

The terms “invention,” “the invention,” “this invention” and “the present invention” used in this patent are intended to refer broadly to all the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood, by reference to appropriate portions of the entire specification of this patent, any or all drawings, and each claim.

According to certain embodiments, a robotic cleaner for removing material from a vessel, sump such as but not limited to a storage tank includes a chassis, a pair of elongated track members, and a cleaning head. The cleaning head may be nested between the elongated track members such that the elongated track members overlap the cleaning head in a lateral direction. An inlet of the cleaning head may face a forward direction of the robotic cleaner and may receive debris during a cleaning operation.

In some embodiments, the robotic cleaner optionally includes a head guard supported on the cleaning head for controlling debris entering the inlet of the cleaning head.

In various embodiments, a vacuum hose may be connected to an outlet end of the cleaning head and such that the vacuum hose is in fluid communication with the cleaning head.

In certain embodiments, the robotic cleaner includes a pump supported that generates a vacuum force for drawing the debris into the cleaning head during the cleaning operation. Optionally, the pump may be supported at an oblique angle relative to an axis of the robotic cleaner extending in the forward direction. Optionally, a pump outlet is offset in the lateral direction relative to a pump inlet of the pump.

Optionally, a mounting plate for supporting a pump and/or vacuum hose may be on the chassis, and the mounting plate may include a central axis at an oblique angle relative to an axis of the robotic cleaner extending in the forward direction.

In certain embodiments, the robotic cleaner optionally includes a sensor support on the cleaning head. A sensor, such as but not limited to a camera and/or a LIDAR sensor, may be supported on the sensor support.

Various implementations described in the present disclosure can include additional systems, methods, features, and advantages, which cannot necessarily be expressly disclosed herein but will be apparent to one of ordinary skill in die art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of die following figures are illustrated to emphasize the general principles of the present disclosure. Corresponding features and components throughout the figures can be designated by matching reference characters for the sake of consistency and clarity.

FIG. 1 illustrates a robotic cleaner for cleaning a vessel according to embodiments.

FIG. 2 is another view of the robotic cleaner of FIG. 1.

FIG. 3 is another view of the robotic cleaner of FIG. 1.

FIG. 4 illustrates a robotic cleaner for cleaning a vessel according to embodiments.

FIG. 5 is another view of the robotic cleaner of FIG. 4.

FIG. 6 is another view of the robotic cleaner of FIG. 4.

FIG. 7 illustrates a robotic cleaner for cleaning a vessel and with a vacuum hose according to embodiments.

FIG. 8 is another view of the robotic cleaner of FIG. 7.

FIG. 9 is another view of the robotic cleaner of FIG. 7.

### DETAILED DESCRIPTION

Described herein are robotic cleaners for storage tanks, online sumps, and other vessels and for performing various tasks within such tanks that would otherwise be dangerous for humans to perform. In certain embodiments, the robotic cleaners described herein may have a compact size compared to traditional cleaners, thereby allowing for such robotic cleaners to be positioned within opening to tanks or vessels that traditionally would prevent or limit the types of cleaners that could be inserted. The compact size of the robotic cleaners described herein also allows for improved maneuverability of the robotic cleaner within the confined space of a storage tank or other vessel. As a non-limiting example, the robotic cleaners described herein may have an improved ability to turn and/or change direction while travelling along a surface of the storage tank or vessel. In certain embodiments, the robotic cleaners described herein may have an improved configuration and/or compact size by nesting a cleaning head between elongated track members of the robotic cleaner, which may reduce the overall length of the robotic cleaner compared to traditional approaches. In some non-limiting examples, the robotic cleaners described herein may have (i) a length less than about 6 ft., such as less than about 5.5 ft., and/or (ii) a width less than about 3 ft., such as less than about 2.5 ft, and/or (iii) a height less than about 2 ft., such as less than about 1.5 ft.

Additionally, or alternatively, the robotic cleaners described herein may support a pump and/or vacuum hose at an oblique angle, which may reduce the overall height of the robotic cleaner compared to traditional approaches. In certain embodiments, the robotic cleaners described herein may include a sensor support on the cleaning head for supporting sensors such as but not limited to visual sensors (e.g., cameras) and/or distance sensors (e.g., LIDAR, SONAR, and/or time-of-flight sensors). In such embodiments, data gathered by the sensor(s) supported on the cleaning head may be utilized to control and/or improve an operation of the robotic cleaner. Various other benefits and advantages may be realized with the systems and methods provided herein, and the aforementioned advantages should not be considered limiting.

While the rise robotic cleaners described below are discussed in the context of storage tanks for chemical and petrochemical industries, they are by no means so limited. Rather, embodiments of the robotic cleaners described herein may be used for various storage tanks, vessels, and/or other enclosed spaces as desired, and may be particularly useful for (although not limited to) environments that may be hazardous or dangerous to human operators.

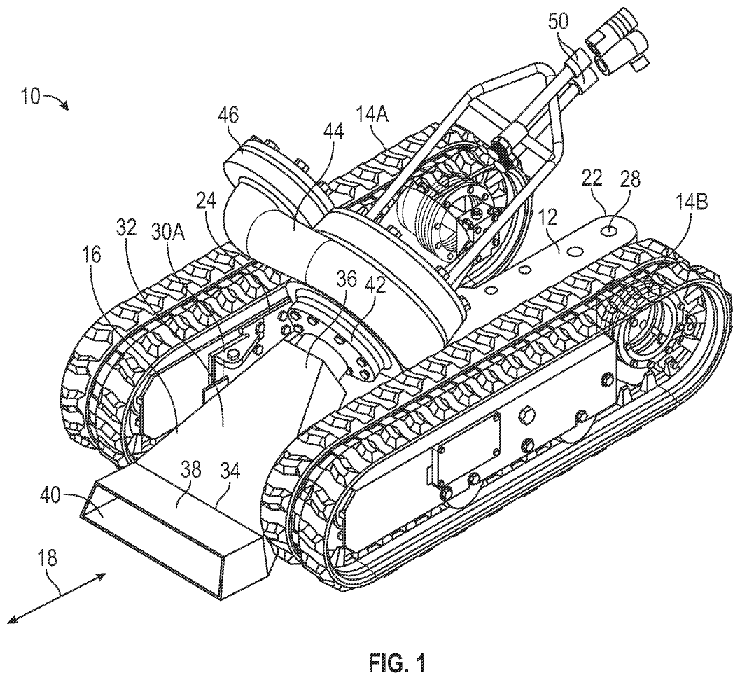

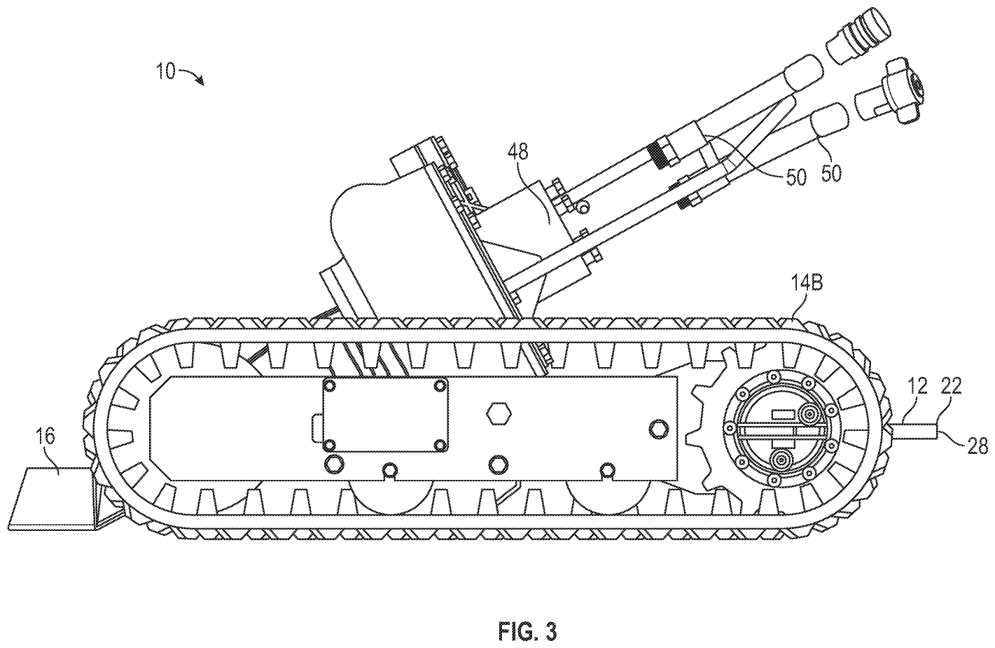

FIGS. 1-3 illustrate an example of a robotic cleaner 10 for cleaning a storage tank, sump or vessel according to embodiments. The robotic cleaner 10 generally includes a chassis 12, a first elongated track member 14A, a second elongated track member 14B, and a cleaning head 16.

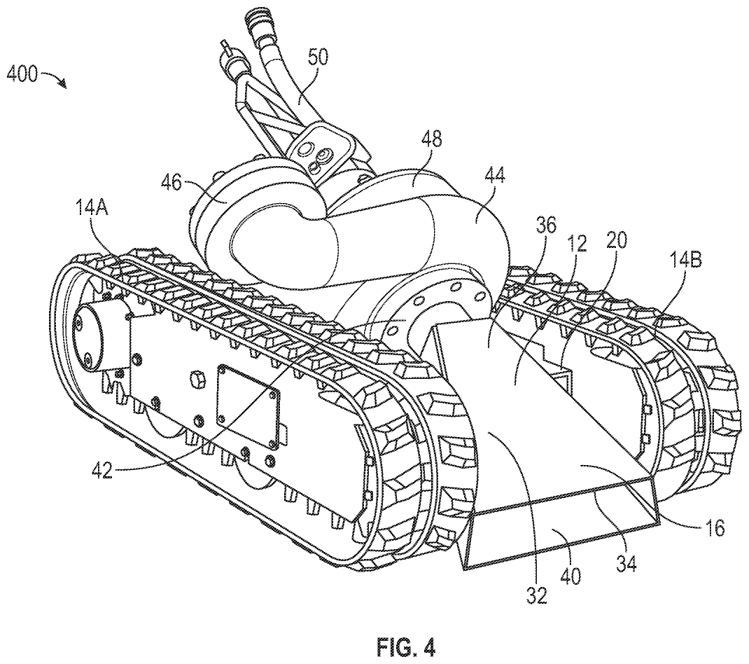

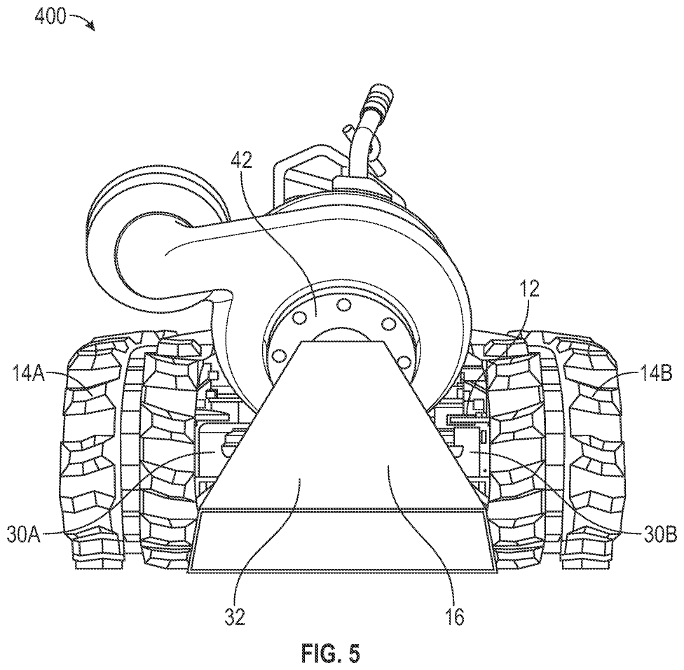

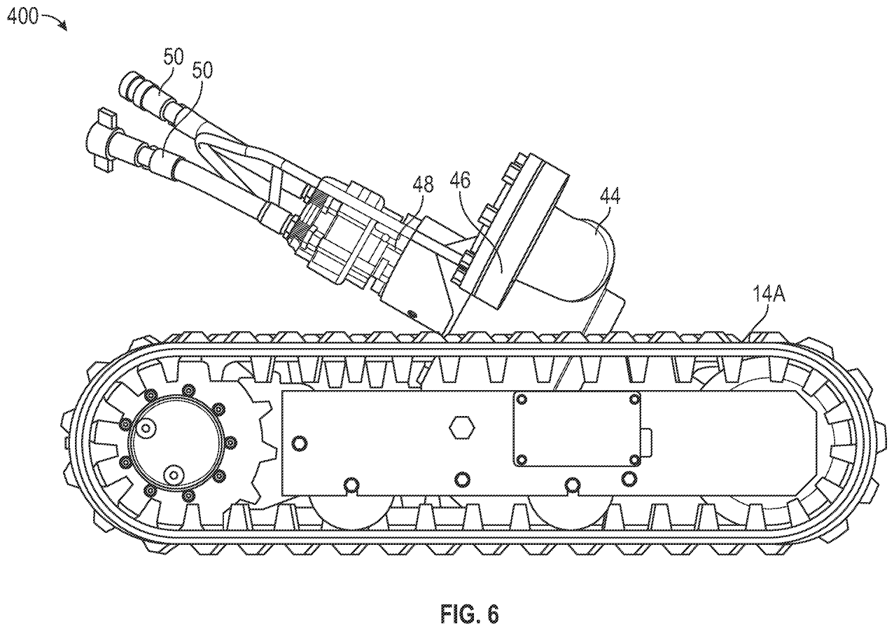

The chassis 12 of the robotic cleaner 10 may directly or indirectly support various components of the robotic cleaner 10 and may be constructed from various materials as desired. The chassis 12 may have various shapes as desired, and in certain embodiments, the chassis 12 may be elongated in a forward and aft direction 18 of the robotic cleaner 10 and nominally includes a forward end 20, an aft end 22, a first lateral side 24, and a second lateral side 26. In the embodiment illustrated in FIGS. 1-3, the chassis 12 is a plate-like structure, although it need not be in other embodiments. Optionally, the aft end 22 includes a tail portion 28. The tail portion 28 may be utilized for positioning the robotic cleaner 10 within a storage tank, supporting sub-components of the robotic cleaner 10, and/or be an attachment location for a tether when the robotic cleaner 10 is performing an operation within the storage tank. In other embodiments, the tail portion 28 may be omitted (see, e.g., FIGS. 4-6).

The first lateral side 24 of the chassis 12 includes one or more features for connecting the first elongated track member 14A to the chassis 12, and the second lateral side 26 likewise includes one or more features for connecting the second elongated track member 14B to the chassis 12. The one or more features for connecting the track members 14A-B may provide a fixed connection between the track members 14A-B and the chassis 12 (e.g., the orientation and/or position of the track members 14A-B is maintained and is unmoving) and/or may provide a movable connection between the track members 14A-B (e.g., the orientation and/or position of the track members 14A-B may be adjusted during operation of the robotic cleaner 10). In the example illustrated, the chassis 12 includes two first pivot points 30A for connecting the first elongated track member 14A to the chassis 12 and two second pivot points 30B for connecting the second elongated track member 14B to the chassis 12. In this embodiment, the pivot pints 30A-B may allow for movement of the elongated track members 14A-B relative to the chassis 12 (e.g., the first elongated track member 14A may pivot to be more forward relative to the second elongated track member 14B). Various other movements may be performed by the elongated track members 14A-B as desired. As mentioned, in other embodiments, a position or orientation of the elongated track members 14A-B relative to the chassis 12 need not be adjustable.

The elongated track members 14A-B may be endless tracks suitable for moving the robotic cleaner 10 along a surface. In certain embodiments, a motor may drive one or both elongated track members 14A-B. In certain embodiments, each elongated track member 14A-B includes a dedicated motor such that the elongated track members 14A-B are separately driven and/or controlled. In various embodiments, the motor(s) may be supported on the elongated track member(s) and/or on other portions of the robotic cleaner 10 as desired.

The cleaning head 16 may be supported by the chassis 12 and generally includes an elongated body 32 having a first end 34 and a second end 36. In certain embodiments, the cleaning head 16 is fixed and is not movable relative to the chassis 12. The elongated body 32 may be generally hollow from the first end 34 to the second end 36 such that material can be drawn into the cleaning head 16 during a cleaning operation such as vacuuming, pumping, etc. In the embodiment illustrated, the first end 34 includes an extension 38 extending in the forward direction, and the extension 38 defines an inlet 40 to the cleaning head 16 that faces the forward direction of the robotic cleaner 10. In other embodiments, and as illustrated in FIGS. 4-6, the extension 38 may be omitted. In such embodiments, omission of the extension 38 may provide a more compact configuration for the robotic cleaner 10.

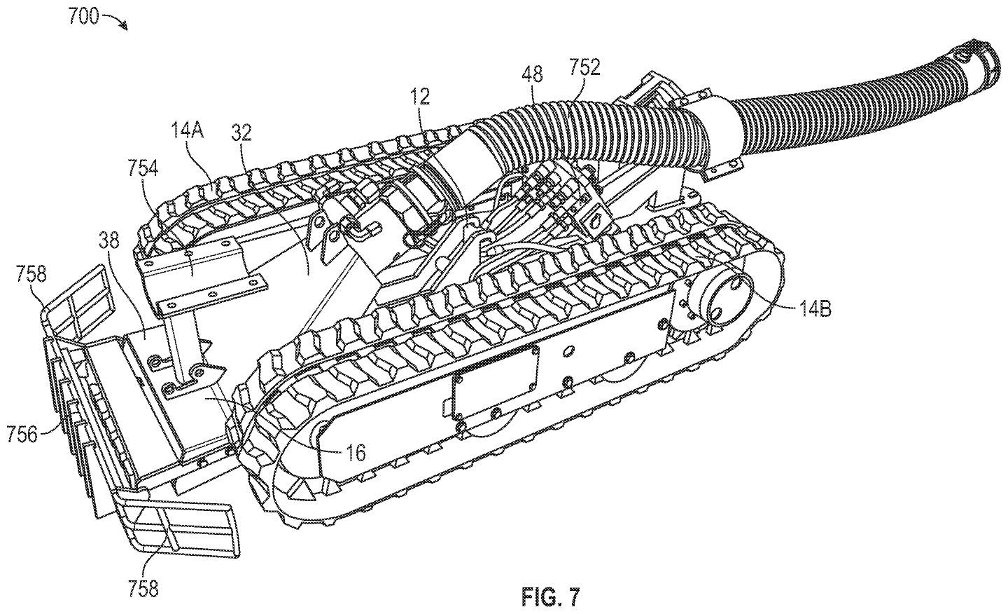

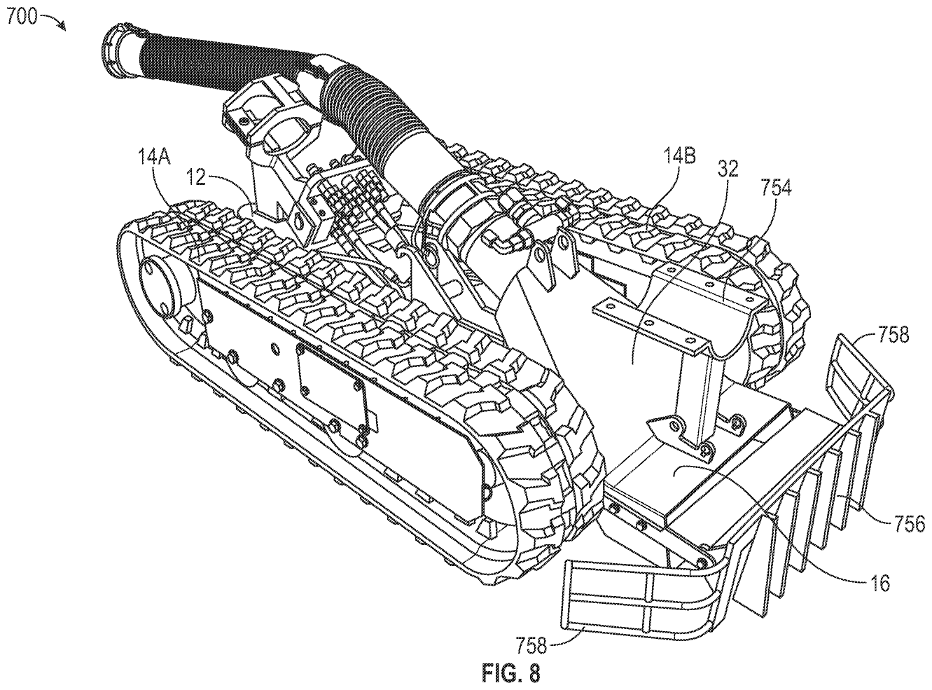

The second end 36 of the elongated body 32 defines an outlet. A vacuum hose, pump, or other component depending on desired function of the robotic cleaner 10 may be coupled to the cleaning head 16 at the second end 36. In the embodiment illustrated, a pump 44 is coupled to the cleaning head 16 at the second end 36 such that the robotic cleaner 10 can perform a pumping operation and draw debris into the cleaning head 16. In the embodiment illustrated, the pump 44 includes an outlet 46 that is laterally offset from the second end 36, which may further reduce the overall height of the robotic cleaner 10. In other embodiments, other types of pumps 44 may be supported on the robotic cleaner 10, and the pump illustrated should not be considered limiting. In further embodiments, another component such as a vacuum hose (see, e.g., FIGS. 7 and 8) may be coupled to the second end 36.

In certain embodiments, the second end 36 includes a mounting plate 42 to facilitate coupling of the cleaning head 16 to the additional component (vacuum hose, pump, etc.). In various embodiments, the mounting plate 42 is arranged at an oblique angle relative to the forward and aft direction 18. The mounting plate 42 at an oblique angle may facilitate direct coupling of the cleaning head 16 to the additional component and may minimize the height of the robotic cleaner 10 due to such coupling with the additional components. As non-limiting examples, the overall height of the robotic cleaner 10 may be less than about 2 ft., such as less than about 1.5 ft. In certain embodiments, the oblique angle of the mounting plate 42 may be from about 10° to about 80°, such as from about 20° to about 70°, such as from about 30° to about 60°, such as from about 40° to about 50°, such as about 45°.

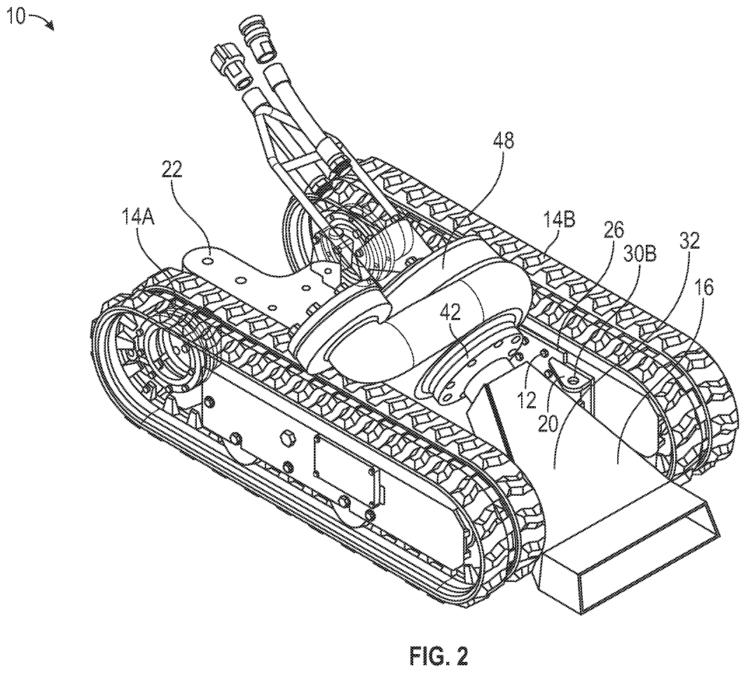

As best illustrated in FIGS. 1 and 2, the elongated body 32 is nested between the elongated track members 14A-B such that the elongated track members 14A-B overlap the cleaning head 16 in a lateral direction. In such embodiments, the elongated track members 14A-B may be outermost components of the robotic cleaner 10 in the lateral direction. In other words, a lateral distance from the first elongated track member 14A to the elongated track member 14B may be the greatest dimension of the robotic cleaner 10 in the lateral direction. The cleaning head 16 nested between the elongated track members 14A-B may provide a compact robotic cleaner 10 with improved maneuverability.

The robotic cleaner 10 may include one or more nozzles for providing fluid, such as water or other fluids, at high pressures to fluidize target material or debris. The one or more nozzles may be provided at various locations, such as but not limited to on the chassis 12, on an exterior of the cleaning head 16, and/or within the cleaning head 16. When included, the target material fluidized by the one or more nozzles and/or other debris may be drawn into the cleaning head 16 during a cleaning operation. In the embodiment of FIGS. 1-3, nozzles are provided within the cleaning head 16.

In certain embodiments, the robotic cleaner 10 includes a coupling plate 48 for coupling one or more fluid and/or electrical lines 50 (e.g., umbilical, fluid hoses, etc.) to the robotic cleaner 10. In various embodiments, the coupling plate 48 is arranged at an oblique angle relative to the forward and aft direction 18. The coupling plate 48 at an oblique angle may facilitate direct coupling of the fluid and/or electrical lines 50 to the robotic cleaner 10 while minimizing the overall height the robotic cleaner 10. The coupling plate 48 at the oblique angle may also vertically position the lines 50 relative to the robotic cleaner to minimize or prevent the robotic cleaner 10 from running over the lines 50 when the robotic cleaner 10 is reversing. In certain embodiments, the oblique angle of the coupling plate 48 may be from about 107 to about 80°, such as from about 20° to about 70°, such as from about 30° to about 60°, such as from about 40° to about 50° such as about 45°.

Other components may be provided on the robotic cleaner 10 as desired, such as but not limited to an onboard power source, a controller (processor and/or memory) for controlling the robotic cleaner 10, various sensors, etc. Additionally, or alternatively, a controller may be provided remote from the robotic cleaner 10. In such embodiments, the controller may communicate with the robotic cleaner 10 via a wired connection (e.g., electrical line 50) or wireless communication.

FIGS. 4-6 illustrate another example of a robotic cleaner 400 according to embodiments. The robotic cleaner 400 is substantially similar to the robotic cleaner 10 except that the cleaning head 16 of the robotic cleaner 400 omits the extension 38, and the first end 34 of the elongated body 32 defines the inlet 40 to the cleaning head 16 facing the forward direction. Similar to the robotic cleaner 10, the cleaning head 16 of the robotic cleaner 400 is nested between the elongated track members 14A-B.

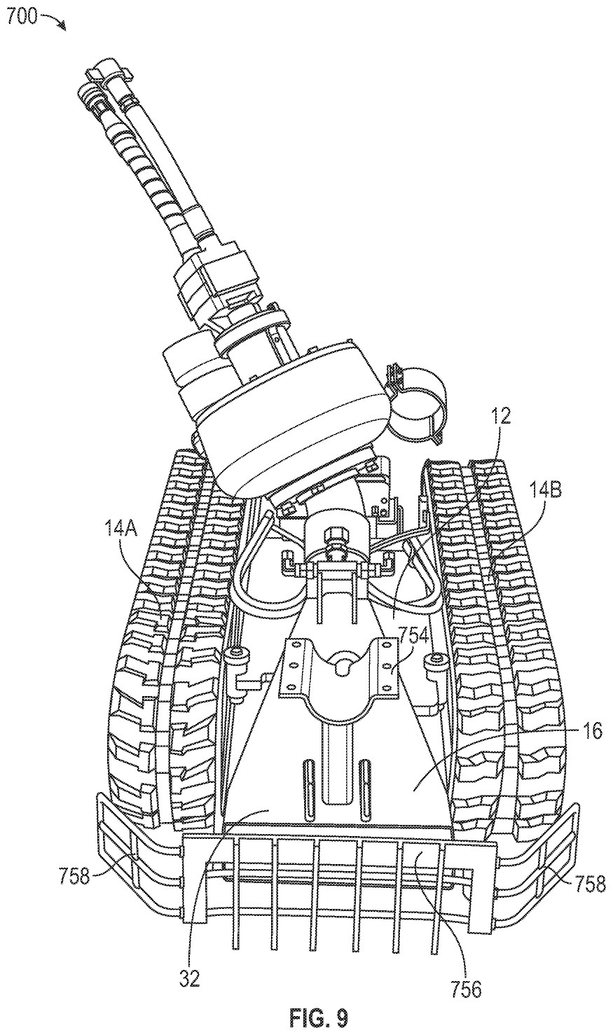

FIGS. 7-9 illustrate another example of a robotic cleaner 700 according to embodiments. The robotic cleaner 700 is similar to the robotic cleaner 10 and includes the cleaning head 16 with the extension 38. Compared to the robotic cleaner 10, a vacuum hose 752 is coupled to the cleaning head 16 in place of the pump 44.

As illustrated in FIGS. 7-9, the cleaning head 16 of the robotic cleaner 700 further includes a sensor support 754. The sensor support 754 may extend from the extension 38 as illustrated, although in other embodiments the sensor support 754 may extend from the elongated body 32. The sensor support 754 may support various sensors on the robotic cleaner 700, such as but not limited to distance sensors, proximity sensors, optical sensor, visual sensors, etc. As non-limiting examples, the sensors may be a LIDAR sensor, a time-of-flight sensor, a camera, etc. In certain embodiments, the sensor support 754 supports the sensor(s) such that a sensing region for the sensor(s) is in the forward direction of the robotic cleaner 700.

In various embodiments, the cleaning head 16 of the robotic cleaner 700 further includes a head guard 756. In various embodiments, the head guard 756 may include one or more opening 760 for controlling to flow of debris or material into the cleaning head 16. Additionally, or alternatively, the head guard 756 may provide protection to the robotic cleaner 700 and allow for the robotic cleaner 700 to bounce or otherwise avoid unseen obstacles during an operation of the robotic cleaner 700. In certain embodiments, the head guard 756 includes extensions 758 that overlap the elongated track members 14A-B in the forward direction. The extensions 758 may provide further protection to the robotic cleaner 700 by limiting or preventing debris or other obstacles from interfering with the elongated track members 14A-B and further allow the robotic cleaner 700 to bounce or otherwise avoid unseen obstacles during an operation of the robotic cleaner 700.

As mentioned, various other benefits and advantages may be realized with the systems and methods provided herein, and the aforementioned advantages should not be considered limiting. The various aspects, embodiments, implementations or features of the described embodiments can be used separately or in any combination. It should be appreciated that the various elements of concepts from the figures may be combined without departing from the spirit or scope of die invention.

The use of the terms “a” and “an” and “the” and similar referents in the context of describing the invention (especially in the context of die following claims) are to be construed to cover both the singular and the plural, unless otherwise indicated herein or clearly contradicted by context. Directional references such as “up,” “down,” “top,” “bottom,” “left,” “right,” “front,” and “back,” among others, are intended to refer to the orientation as illustrated and described in the figure (or figures) to which the components and directions are referencing. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, the nearness of completion will be so as to have the same overall result as if absolute and total completion were obtained.

Preferred embodiments of this invention are described herein, including the best mode known to the inventors for carrying out the invention. The invention is susceptible to various modifications and alternative constructions, and certain shown exemplary embodiments thereof are shown in the drawings and have been described above in detail. Variations of those preferred embodiments, within the spirit of the present invention, may become apparent to those of ordinary skill in die art upon reading the foregoing description. The inventors expect skilled artisans to employ such variations as appropriate, and the inventors intend for the invention to be practiced otherwise than as specifically described herein. Accordingly, it should be understood that there is no intention to limit the invention to die specific form or forms disclosed, but on the contrary, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

That which is claimed:

1. A robotic cleaner for removing material from a vessel, the robotic cleaner comprising:
a chassis;
a first elongated track member coupled to a first side of the chassis;
a second elongated track member coupled to a second side of the chassis and such that the chassis is between the first elongated track member and the second elongated track member, wherein the robotic cleaner is movable along a surface using the first elongated track member and the second elongated track member, and
a cleaning head supported by the chassis, the cleaning head comprising a body defining an inlet facing a forward direction of the robotic cleaner, wherein the body is positioned between the first elongated track member and the second elongated track member such that the first elongated track member and the second elongated track member overlap the cleaning head in a lateral direction, wherein the inlet is configured to receive debris during a cleaning operation of the robotic cleaner.

2. The robotic cleaner of claim 1, further comprising a vacuum hose connected to an outlet end of the cleaning head and such that the vacuum hose is in fluid communication with the cleaning head.

3. The robotic cleaner of claim 1, further comprising a pump supported on the chassis and connected to an outlet end of the cleaning head such that the pump is in fluid communication with the cleaning head, wherein the pump is configured to draw the debris into the cleaning head during the cleaning operation.

4. The robotic cleaner of claim 3, further comprising a mounting plate connecting the pump with the cleaning head, wherein the mounting plate is at an oblique angle relative to an axis of the robotic cleaner extending in the forward direction.

5. The robotic cleaner of claim 4, wherein the oblique angle is a 450 angle relative to the axis.

6. The robotic cleaner of claim 3, wherein the pump comprises a pump outlet and a pump inlet, and wherein the pump outlet is offset in the lateral direction relative to the pump inlet.

7. The robotic cleaner of claim 1, further comprising a head guard supported on the cleaning head and configured to control debris entering the inlet of the cleaning head.

8. The robotic cleaner of claim 7, wherein the head guard overlaps the first elongated track member and the second elongated track member in the forward direction of the robotic cleaner.

9. The robotic cleaner of claim 1, further comprising a sensor support on the cleaning head, the sensor support configured to support a sensor on the robotic cleaner.

10. The robotic cleaner of claim 9, further comprising a camera or a LIDAR sensor supported on the sensor support, wherein the camera or LIDAR sensor define a sensing region in the forward direction.

11. The robotic cleaner of claim 1, further comprising a controller configured to control operation of the robotic cleaner, wherein the controller is on board the robotic cleaner.

12. A cleaning system comprising the robotic cleaner of claim 1 and a controller configured to control operation of the robotic cleaner, wherein the controller is remote from the robotic cleaner.

13. A robotic cleaner for removing material from a vessel, the robotic cleaner comprising:
a chassis;
a first elongated track member coupled to the chassis and defining a first lateral side of the robotic cleaner;
a second elongated track member coupled to the chassis and defining a second lateral side of the robotic cleaner, wherein a distance from the first lateral side to the second lateral side is a greatest dimension of the robotic cleaner in a lateral direction, wherein the robotic cleaner is movable along a surface using the first elongated track member and the second elongated track member; and
a cleaning head supported by the chassis and nested between the first elongated track member and the second elongated track member, the cleaning head comprising a body defining an inlet facing a forward direction of the robotic cleaner.

14. The robotic cleaner of claim 13, wherein the body of the cleaning head is elongated and extends upwardly at an oblique angle relative to an axis of the robotic cleaner extending in the forward direction.

15. The robotic cleaner of claim 13, further comprising a vacuum hose connected to an outlet of the cleaning head.

16. The robotic cleaner of claim 13, further comprising a mounting plate connected to an outlet of the cleaning head, wherein the mounting plate is at an oblique angle relative to an axis of the robotic cleaner extending in the forward direction.

17. The robotic cleaner of claim 16, further comprising a pump supported on the mounting plate and connected to the outlet of the cleaning head using the mounting plate, wherein the pump is supported at the oblique angle.

18. The robotic cleaner of claim 13, further comprising a head guard supported on the cleaning head and configured to control debris entering the inlet of the cleaning head, wherein the head guard overlaps the first elongated track member and the second elongated track member in the forward direction of the robotic cleaner.

19. The robotic cleaner of claim 13, further comprising a sensor support on the cleaning head, the sensor support configured to support a sensor on the robotic cleaner.

20. The robotic cleaner of claim 19, further comprising a camera or a LIDAR sensor supported on the sensor support, wherein the camera or LIDAR sensor define a sensing region in the forward direction.
